(19) United States
(12) Patent Application Publication
(10) Pub. No.: US 2026/0164138 A1
(43) Pub. Date: Jun. 11, 2026

(54) SIGNAL PROCESSING APPARATUS, PROCESSING METHOD FOR SIGNAL PROCESSING APPARATUS, AND STORAGE MEDIUM

(71) Applicant: CANON KABUSHIKI KAISHA, Tokyo (JP)

(72) Inventor: KATSUYA NAKANO, Kanagawa (JP)

(21) Appl. No.: 19/385,801

(22) Filed: Nov. 11, 2025

(30) Foreign Application Priority Data
Dec. 6, 2024 (JP) 2024-213347

(51) Int. Cl. H04N 23/80; G06N 3/045

(52) U.S. Cl. CPC H04N 23/80; G06N 3/045

(57) ABSTRACT

A signal processing apparatus includes a generation unit configured to generate one or more pieces of first input data, a reception unit configured to receive one or more pieces of second input data from an external device, a calculation unit configured to calculate a delay value of the second input data with respect to the first input data, and a determination unit configured to determine that one neural network model among a plurality of neural network models is to be used, the neural network model receiving input of either or both of the first input data and the second input data depending on the delay value calculated by the calculation unit.

### BACKGROUND

### Field of the Technology

The present disclosure relates to a signal processing apparatus, a processing method for the signal processing apparatus, and a storage medium.

### Description of the Related Art

A deep learning technique using a neural network has been applied across a wide range of technical fields. In particular, class classification that involves recognizing and classifying images is said to have surpassed human recognition capabilities. A convolutional neural network (CNN), which has been especially widely used among others, recursively performs convolution computation on images to implement deep learning processing with high accuracy.

In recent years, using such deep learning processing, the CNN has been applied to facial expression recognition processing to recognize facial expressions included in captured images. The facial expression recognition processing improves accuracy of recognizing facial expressions mainly from information extracted from images such as surface irregularities, texture, or contours of faces. However, since recognition is performed based on only single modal information such as captured images, the improvement in accuracy is not sufficient.

Accordingly, attention has recently been focused on an artificial intelligence (AI) technique called multi-modal AI that is capable of processing multiple types of information such as text, images, audio, and moving images at once. It has been reported that the use of a multi-modal AI technique improves accuracy of inference processing in comparison with single-type AI processing.

Japanese Patent Laid-Open No. 2022-2023 describes a technique for performing deep learning processing using multiple pieces of modal information. According to Japanese Patent Laid-Open No. 2022-2023, by training a plurality of inference models using the multiple pieces of modal information in an integrated manner, it is possible to improve accuracy of an inference result in comparison with a case of training with a single piece of model information.

However, even when the technique described in Japanese Patent Laid-Open No. 2022-2023 is used, in a case where some pieces of modal information among the multiple pieces of modal information are delayed as input data, the start of deep learning processing is delayed. Accordingly, in a real-time system in which it is necessary to obtain a processing result within a specific time, there is an issue that a processing result may not be obtained in time. Furthermore, there is an issue that, if the deep learning processing is started before preparation of the delayed input data is completed, the accuracy of the processing result may deteriorate.

### SUMMARY

According to an aspect of the present disclosure, a signal processing apparatus includes a generation unit configured to generate one or more pieces of first input data, a reception unit configured to receive one or more pieces of second input data from an external device, a calculation unit configured to calculate a delay value of the second input data with respect to the first input data, and a determination unit configured to determine that one neural network model among a plurality of neural network models is to be used, the neural network model receiving input of either or both of the first input data and the second input data depending on the delay value calculated by the calculation unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of an overall configuration of a signal processing apparatus according to one or more aspects of the present disclosure.

FIG. 2 is a block diagram illustrating an example of a configuration of the signal processing apparatus according to one or more aspects of the present disclosure.

FIG. 3 is a flowchart illustrating an example of a series of processes until execution of neural network processing using an image captured by the signal processing apparatus according to the first embodiment and audio acquired from an external device as input to a neural network model.

FIG. 4 is a diagram illustrating an example of a sequence of communication processing for time synchronization between devices according to one or more aspects of the present disclosure.

FIG. 5 is a flowchart illustrating an example of a series of processes until the signal processing apparatus according to one or more aspects of the present disclosure determines a neural network model.

FIGS. 6A to 6C are diagrams each illustrating an example of a configuration of a neural network model used by the signal processing apparatus according to one or more aspects of the present disclosure.

FIGS. 7A to 7C are timing charts each illustrating timings of a series of processes until execution of neural network processing using an image captured by the signal processing apparatus according one or more aspects of the present disclosure and audio acquired from an external device as input to a neural network model.

### DESCRIPTION OF THE EMBODIMENTS

Examples of favorable embodiments of the present disclosure will be described in detail below based on the drawings.

### [First Embodiment]

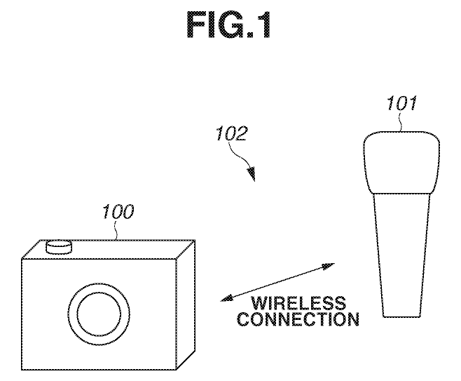

FIG. 1 is a diagram illustrating a configuration example of a signal processing system 102 according to a first embodiment. The signal processing system 102 includes a digital camera (signal processing apparatus) 100 and a wireless microphone 101. The wireless microphone 101 is an external microphone that is wirelessly connected to the digital camera 100.

The digital camera 100 is an example of a signal processing apparatus and is wirelessly connectable to the wireless microphone 101 in conformity with a Bluetooth (registered trademark) standard. In wireless connection in conformity with the Bluetooth standard, the digital camera 100 is, in synchronous communication, capable of receiving audio data and the like from the wireless microphone 101.

Further, in the wireless connection in conformity with the Bluetooth standard, the digital camera 100 is, in asynchronous communication, capable of transmitting control data such as an output instruction to the wireless microphone 101. A user wirelessly connects the wireless microphone 101 to the digital camera 100, which makes it possible for the digital camera 100 to receive sound information from a remote sound source via the wireless microphone 101.

### <Configuration of Digital Camera 100>

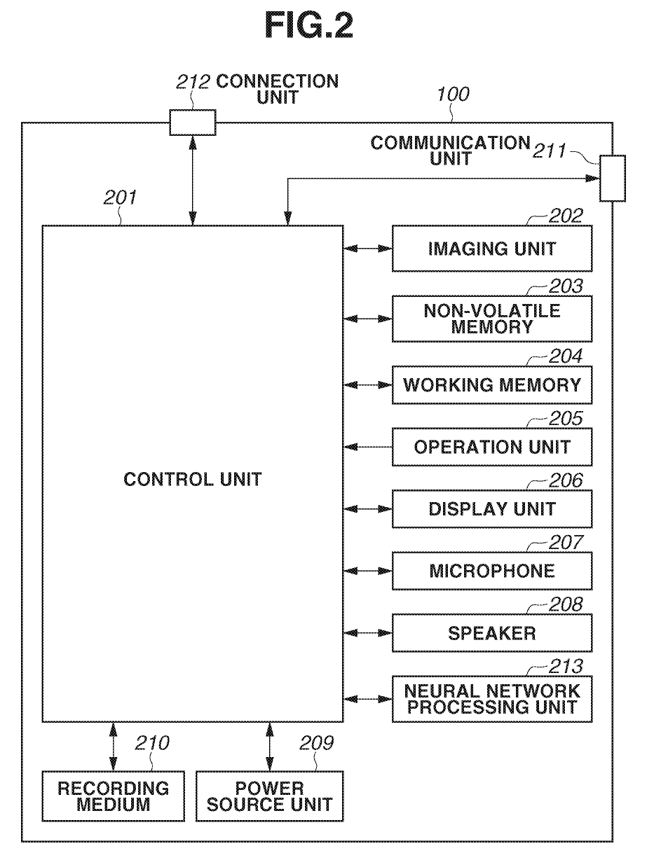

FIG. 2 is a block diagram illustrating a configuration example of the digital camera 100 that is an example of the signal processing apparatus according to the present embodiment. Here, the digital camera 100 is described as an example of the signal processing apparatus, but the signal processing apparatus is not limited thereto. For example, the signal processing apparatus may be a smartphone, a personal computer, a smart watch, or a tablet terminal.

The digital camera 100 includes a control unit 201, an imaging unit 202, a non-volatile memory 203, a working memory 204, an operation unit 205, a display unit 206, a microphone 207, a speaker 208, a power source unit 209, a recording medium 210, a communication unit 211, a connection unit 212, and a neural network processing unit 213.

The control unit 201 controls each unit of the digital camera 100 based on input signals and execution of a program, which will be described below. The control unit 201 controls, in conjunction with the communication unit 211, time synchronization with an external device. The control unit 201 periodically exchanges time information with the external device to perform time synchronization with the external device. Further, the control unit 201 determines a model to be used among neural network models that are used for neural network processing and that are recorded in the non-volatile memory 203 and the recording medium 210, which will be described below. Instead of the control unit 201 controlling the entire digital camera 100, a plurality of hardware devices sharing the load of processing may control the entire digital camera 100.

The imaging unit 202 includes, for example, an optical system that controls an optical lens unit, an aperture, zoom, focus, and the like, and an image pickup element for converting light (video images) introduced through the optical lens unit into electrical video signals. Under control of the control unit 201, the imaging unit 202 converts subject light, which is formed as an image by a lens included in the imaging unit 202, into electrical signals using the image pickup element, and performs noise reduction processing or the like thereon, and outputs digital data as image data or moving image data. Further, the imaging unit 202 includes a shutter capable of freely controlling exposure time of the image pickup element under control of the control unit 201.

The non-volatile memory 203 is an electrically erasable and recordable non-volatile memory, in which a below-described program to be executed by the control unit 201 and the like are stored. Further, a plurality of neural network models is recorded in the non-volatile memory 203. The neural network model may be, for example, a neural network model that supports multi-modal processing using two types of data, namely, audio and images, as input, or a neural network model that supports single-modal processing using only images as the input.

The working memory 204 is used as a buffer memory that temporarily holds image data and moving image data captured by the imaging unit 202, a memory for image display of the display unit 206, a working area for the control unit 201, and the like. The working memory 204 is also used as a temporary storage area when the neural network processing unit 213 performs neural network computation.

The operation unit 205 is a user interface (UI) for accepting an instruction to the digital camera 100 from the user. The operation unit 205 can include, for example, a power switch used by the user to issue an instruction for powering ON/OFF the digital camera 100, a release switch to issue an instruction for imaging, and a playback button to issue an instruction for reproducing image data. Further, a touch panel formed in the display unit 206 can also be included in the operation unit 205.

The release switch includes a switch SW1 and a switch SW2. When the release switch is in what is called a half-press state, the switch SW1 is turned ON. With this operation, the digital camera 100 accepts a preparation instruction for performing a preparation operation for imaging such as auto focus (AF) processing, auto exposure (AE) processing, auto white balance (AWB) processing, or electronic flash (EF) (flash preliminary light emission) processing. Further, when the release switch is in what is called a fully-pressed state, the switch SW2 is turned ON. With such a user operation, the digital camera 100 accepts an imaging instruction for performing an imaging operation.

The display unit 206 displays view finder images at the time of imaging, captured image data, texts for an interactive operation, and the like. The display unit 206 may not necessarily be built into the digital camera 100, and may be configured to be externally connected to the digital camera 100. The digital camera 100 can be connected to the internal or external display unit 206, and is only required to have a display control function to control display of the display unit 206.

The microphone 207 is used to input sound waves, such as sounds and audio, to the digital camera 100. The microphone 207 converts the sounds and audio into electrical signals and inputs the electrical signals into the digital camera 100.

The control unit 201 generates audio data from the input electrical signals. For example, the control unit 201 is capable of recording the audio data and the moving image data captured by the imaging unit 202 in synchronization with each other. Further, for example, the control unit 201 is capable of recording the audio data and the image data captured by the imaging unit 202 in association with each other.

The microphone 207 may be configured to be detachably mountable to the digital camera 100 or may be built into the digital camera 100. In other words, the digital camera 100 is only required to include at least a unit for receiving electrical signals from the microphone 207. Further, in a case where the wireless microphone 101 is connected to the digital camera 100 using the communication unit 211, the digital camera 100 is capable of recording audio input from the wireless microphone 101 in synchronization with captured moving image data without using audio input from the microphone 207.

The speaker 208 is an electroacoustic transducer capable of outputting electronic sound. In the present embodiment, the control unit 201 is capable of converting audio data recorded in the non-volatile memory 203 into audio signals, and outputting the audio signals from the speaker 208.

Under the control of the control unit 201, the power source unit 209 is capable of supplying power to each element of the digital camera 100. The power source unit 209 is, for example, a power source such as a lithium-ion battery or an alkaline manganese dry cell.

The recording medium 210 is capable of recording, for example, image data output from the imaging unit 202. The recording medium 210 is, for example, a memory card. The recording medium 210 may be configured to be detachably mountable to the digital camera 100 or may be built into the digital camera 100. In other words, the digital camera 100 is only required to include at least a unit for accessing the recording medium 210.

The communication unit 211 is an interface for wireless connection with an external device. The digital camera 100 according to the present embodiment is capable of exchanging data with the external device via the communication unit 211. For example, the control unit 201 is capable of transmitting image data generated in the imaging unit 202 or audio data recorded in the non-volatile memory 203 to the external device via the communication unit 211. The external device is, for example, an information device such as a smartphone or a personal computer (PC), an external speaker such as an earphone or a headphone, or a flash unit.

In the present embodiment, the communication unit 211 includes an interface for communicating with the external device in conformity with the Bluetooth (registered trademark) standard. Hereinafter, wireless communication in conformity with the Bluetooth standard is referred to as Bluetooth communication.

The control unit 201 controls the communication unit 211 and thereby implements wireless communication with the external device.

The communication unit 211 receives audio data from the wireless microphone 101 through Bluetooth communication. Further, the communication unit 211 also performs wireless local area network (LAN) communication with the wireless microphone 101 in conformity with an Institute of Electrical and Electronics Engineers (IEEE) 802.11 standard.

The communication unit 211 performs time synchronization communication with the wireless microphone 101 using the wireless LAN communication. The time synchronization communication refers to communication for synchronizing time between devices using a Precision Time Protocol (PTP) standard. With this configuration, the signal processing apparatus 100 and the wireless microphone 101 can have common time information therebetween. Further, the digital camera 100 is also capable of estimating a delay time regarding data from the external device based on the synchronized time information.

The connection unit 212 is an interface for wired connection with the external device. The digital camera 100 according to the present embodiment is capable of exchanging data with the external device via the connection unit 212. For example, the control unit 201 is capable of transmitting image data generated in the imaging unit 202 or moving image data recorded in the non-volatile memory 203 to the external device via the connection unit 212. Further, for example, the control unit 201 is capable of receiving audio signals and audio data from the external device such as the microphone via the connection unit 212.

In a case where the digital camera 100 is connected with the external device such as the microphone or the headphone, the control unit 201 is capable of detecting a type of device after establishing connection with the external device. In Bluetooth communication via the communication unit 211, the control unit 201 is capable of detecting whether the external device is operable as the headphone or the microphone by utilizing Service Discovery Protocol (SDP). Further, for example, in wireless LAN communication via the communication unit 211, the control unit 201 receives the type of device of the external device from the external device and can thereby detect the device type of the external device.

The example of the configuration of the digital camera 100 has been described above.

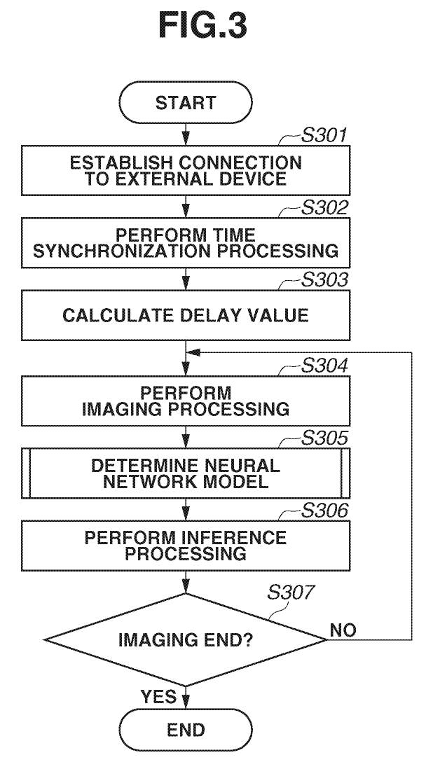

Subsequently, with reference to FIG. 3, a description will be provided of an example of a series of processes until the signal processing apparatus 100 performs neural network processing with use of a captured image generated by the imaging unit 202 and audio information received from the wireless microphone 101 as input to the neural network model. The series of processes is started by the user powering ON the signal processing apparatus 100 using the operation unit 205. A processing method of the signal processing apparatus 100 is described below.

In step S301, the control unit 201 uses the communication unit 211 to check whether there is an external device capable of performing wireless communication, and establishes wireless communication with the identified external device. In the present embodiment, the control unit 201 uses Bluetooth communication with the wireless microphone 101 to communicate audio information, and performs time synchronization communication between devices using wireless LAN communication. Further, step S301 starts not only when the user powers ON the signal processing apparatus 100, but also when the user performs an operation to check whether there is a connectable external device. Furthermore, step S301 starts also when a connected device is changed.

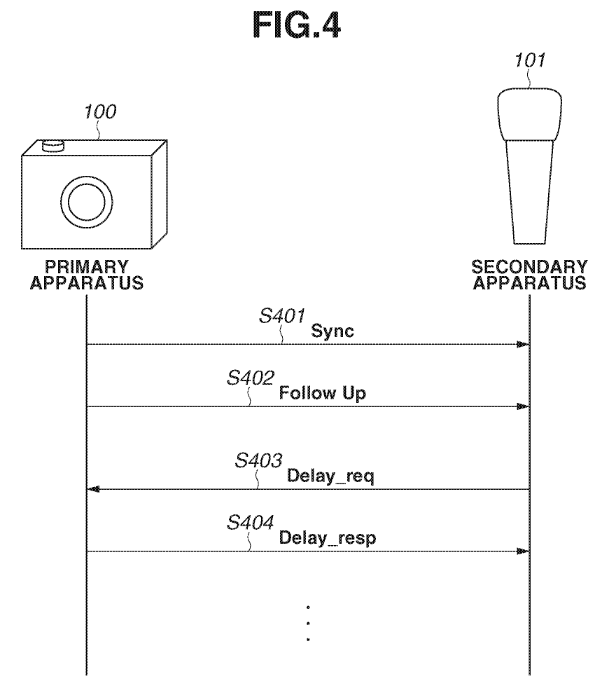

In step S302, the control unit 201 performs time synchronization communication with the wireless microphone 101 using the PTP to synchronize time. Details of communication procedures will be described below with reference to FIG. 4. In the present embodiment, the signal processing apparatus 100 serves as a primary apparatus for time synchronization, and the wireless microphone 101 serves as a secondary apparatus for the time synchronization. The primary apparatus and the secondary apparatus periodically communicate with each other to perform the time synchronization such that the secondary apparatus synchronizes its time with that of the primary apparatus. The control unit 201 performs time synchronization communication to synchronize a time with that of the wireless microphone 101.

In step S303, the control unit 201 starts wirelessly receiving one or more pieces of audio data from the wireless microphone 101. The wireless microphone 101 is an example of the external device. The control unit 201 calculates delay information regarding audio data received by the communication unit 211 from the wireless microphone 101 based on the time synchronized through the time synchronization communication. The wireless microphone 101 records a timing at which audio is captured by the wireless microphone 101 using its own time obtained by the time synchronization, adds time information to audio data, and transmits the audio data to the signal processing apparatus 100. The control unit 201 compares the time information of the audio data received by the communication unit 211 from the wireless microphone 101 with its own time obtained by time synchronization, and calculates a difference from the time at which the audio is captured as a delay value.

In other words, the control unit 201 calculates the delay value of the audio data relative to captured image data described below in step S304. Specifically, the communication unit 211 receives the time information regarding the time at which the audio data is generated from the wireless microphone 101. The control unit 201 calculates a difference between the time information regarding the time at which the audio data is generated and the time of the signal processing apparatus 100 as the delay value.

In step S304, the control unit 201 controls the imaging unit 202 to start capturing a moving image, and generates one or more pieces of captured image data. The control unit 201 uses its own time obtained by time synchronization to record a time at which an image is generated by the imaging unit 202. The control unit 201 compares the time at which the image is captured by the signal processing apparatus 100 with the time at which audio is captured by the wireless microphone 101, and can thereby manage the times at which the image is acquired and at which audio is acquired.

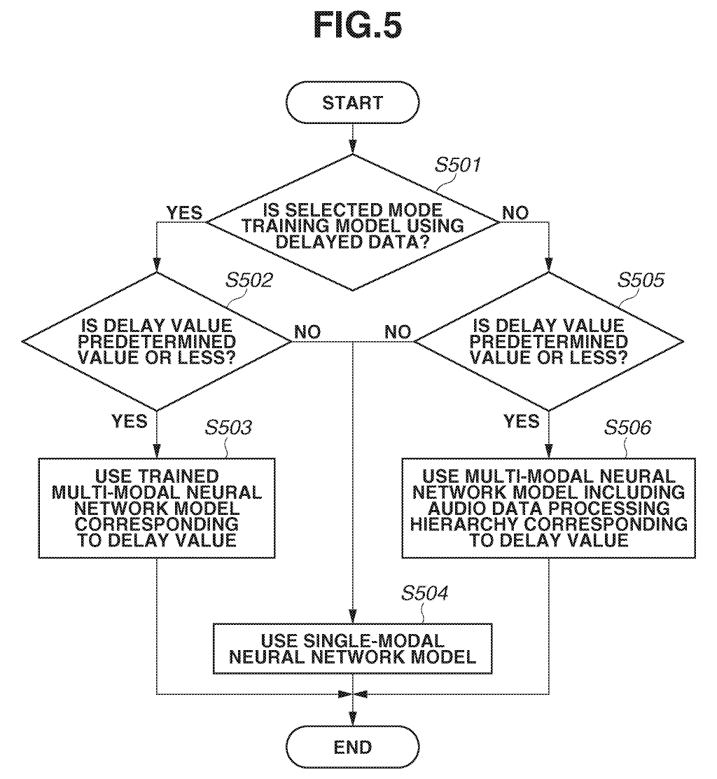

In step S305, the control unit 201 determines a neural network model to be used in the neural network processing based on the calculated delay value regarding the audio data. Details of the processing will be described below with reference to FIG. 5.

In step S306, the control unit 201 transmits data regarding the determined neural network model to the neural network processing unit 213. Subsequently, with respect to two types of input to the neural network model, the control unit 201 performs control to input the captured image generated by the imaging unit 202 and the audio data acquired from the wireless microphone 101 via the communication unit 211 and starts the neural network processing (inference processing).

In step S307, the control unit 201 checks whether an imaging end operation has been performed by the user via the operation unit 205. In a case where the imaging end operation has been performed (YES in step S307), the control unit 201 ends the processing. In a case where the end operation has not been performed (NO in step S307), the processing returns to step S304, and the control unit 201 continues the processing.

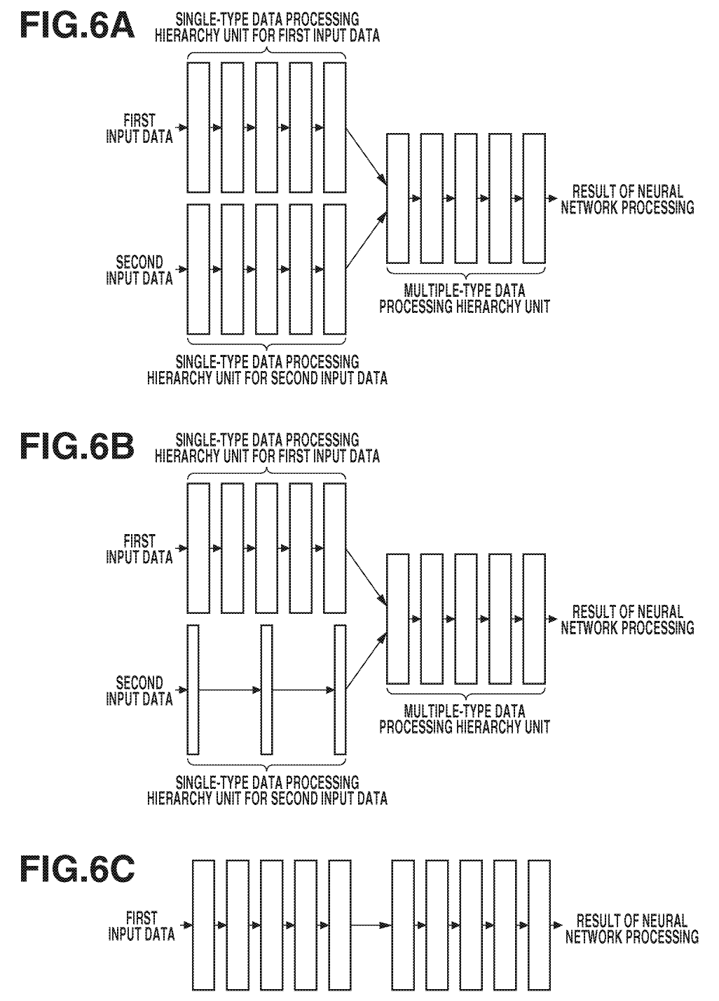

Through the above-mentioned processing sequence, by determining and using a neural network model depending on the difference between the time at which the captured image is acquired and the time at which the audio data is acquired, it is possible to execute optimal neural network processing. Details of the neural network model will be described below with reference to FIGS. 6A to 6C.

Subsequently, details of exchange of packets for the time synchronization between the primary apparatus and the secondary apparatus are described with reference to FIG. 4. The exchange of packets enables estimation of a delay in a network path and allows the secondary apparatus to synchronize its time with that of the primary apparatus in consideration of an amount of the delay. A method introduced in the present embodiment is an example of what is called a two-step method. Besides the two-step method, there are other methods such as a one-step method.

In the present embodiment, the primary apparatus is the signal processing apparatus 100, and the secondary apparatus is the wireless microphone 101.

In step S401 in the sequence, the primary apparatus transmits a Sync packet to the secondary apparatus. In the Sync packet, information indicating that a synchronization method used this time is the two-step method is described. When receiving the Sync packet, the secondary apparatus stores a received time.

In step S402 in the sequence, the primary apparatus transmits a Follow Up packet. The Follow Up packet includes a transmission time of the Sync packet transmitted immediately before. The secondary apparatus can calculate the delay time on a communication path in a direction from the primary apparatus to the secondary apparatus based on a difference between the transmission time of the Sync packet described in the Follow Up packet and a reception time of the Sync packet stored in the secondary apparatus.

In step S403 in the sequence, the secondary apparatus transmits a Delay_req packet to the primary apparatus. The secondary apparatus stores therein a transmission time of the Delay_req packet. The primary apparatus receives the Delay_req packet and stores therein a reception time of the Delay_req packet.

In step S404 in the sequence, the primary apparatus transmits a Delay_resp packet to the secondary apparatus. The Delay_resp packet includes information regarding the reception time of the Delay_req packet received by the primary apparatus. The secondary apparatus can calculate the delay time on the communication path in a direction from the secondary apparatus to the primary apparatus based on a difference between the transmission time of the Delay_req packet and the reception time of the Delay_req packet stored in the Delay_resp packet.

By periodically performing the above-mentioned exchange of the packets, the secondary apparatus can perform a periodical correction to synchronize its time with that of the primary apparatus, which enables periodical time synchronization.

An example of processing of determining the neural network model to be used is described with reference to FIG. 5. FIG. 5 is a flowchart illustrating details of step S305 in FIG. 3.

In step S501, the control unit 201 checks a mode that has been preliminarily set by the user on the operation unit 205. There are two types of modes.

A first mode is a mode in which a model trained using data in a state where predetermined input data among a plurality of pieces of input data is delayed by a certain amount is used in a multi-modal neural network model. The mode is defined as a training model mode using delayed data. In this case, for example, in the multi-modal neural network model that receives captured image data and audio data as input, the neural network model is trained using audio data including audio recorded at a time different from an image capture time. When performing inference processing, the control unit 201 determines to use a model trained using data having a similar delay difference based on the delay value of the input data.

A second mode is a mode in which, in the multi-model neural network model, in a case where predetermined input data among a plurality of pieces of data is delayed by a certain amount, a model configured with fewer hierarchies for processing the delayed data is used. In a case where the audio data is input with a delay relative to the image data, the control unit 201 determines to use a model configured with fewer hierarchies for processing the audio data.

In a case where the selected mode is the training model mode using the delayed data (YES in step S501), the processing proceeds to step S502.

In a case where the selected mode is not the training model mode using the delayed data (NO in step S501), the processing proceeds to step S505.

In step S502, the control unit 201 determines whether the delay value calculated in step S303 in FIG. 3 is a first predetermined value or less. In a case where the calculated delay value is the first predetermined value or less (YES in step S502), the processing proceeds to step S503.

In a case where the calculated delay value is not the first predetermined value or less (NO in step S502), the processing proceeds to step S504.

In step S503, the control unit 201 determines to use a trained multi-modal neural network model corresponding to the delay value.

In step S504, the control unit 201 determines to use a single-modal neural network model.

In step S505, the control unit 201 determines whether the delay value calculated in step S303 in FIG. 3 is a second predetermined value or less. In a case where the calculated delay value is the second predetermined value or less (YES in step S505), the processing proceeds to step S506.

In a case where the calculated delay value is not the second predetermined value or less (NO in step S505), the processing proceeds to step S504.

In step S506, the control unit 201 determines to use a multi-modal neural network model including an audio data processing hierarchy corresponding to the delay value.

As described above, the control unit 201 determines to use the neural network model corresponding to the delay value regarding audio data received from the wireless microphone 101.

Subsequently, neural network models will be described.

First, the trained multi-modal neural network model corresponding to the delay value determined in step S503 is described. The trained multi-modal neural network model corresponding to the delay value receives input of audio data available at a timing at which image data generated by the imaging unit 202 is input to the neural network. For example, in the case of audio data with a delay of one second, audio captured one second prior is input, and data in which the image capture time and the audio capture time are shifted by one second is input to the multi-modal neural network model. Here, with use of a model trained using the data having a shift of one second as training data, it is possible to suppress a decrease in accuracy of inference and complete processing within a real-time constraint.

Subsequently, a description is provided of the multi-modal neural network model including an audio data processing hierarchy corresponding to the delay value with reference to FIGS. 6A to 6C.

FIG. 6A illustrates an example of the multi-modal neural network model for performing neural network processing using multiple types of data in step S503 in FIG. 5. The multi-modal neural network model receives input of two types of data, namely, first input data and second input data, and outputs a result. In the present embodiment, the multi-modal neural network model provided with two types of input data is described, but the types of input data are not limited thereto. The multi-modal neural network model may be provided with three or more types of input data.

Further, in the present embodiment, the captured image data is input as the first input data, and the audio data acquired from the wireless microphone 101 is input as the second input data. For each of the first input data and the second input data, there is a hierarchy that processes a single type of data. This is defined as a single-type data processing hierarchy unit. In a case where the first input data is the captured image data, the single-type data processing hierarchy unit is a hierarchy that processes only the captured image data. The single-type data processing hierarchy unit is configured to perform different processing depending on input data. More specifically, the single-type data processing hierarchy unit that processes the audio data and the single-type data processing hierarchy unit that processes the captured image data have different configurations and different processing contents.

Subsequently, after completion of the processing in the single-type data processing hierarchy unit, there is a hierarchy that performs processing using multiple types of data. This is defined as a multiple-type data processing hierarchy unit. This hierarchy constitutes core processing of the multi-modal neural network model, and by performing neural network processing using multiple types of data, it is possible to output an inference result with high accuracy.

FIG. 6B illustrates an example of the multi-modal neural network model determined in step S506 in FIG. 5, and the multi-modal neural network model is configured to perform reduced processing in a hierarchy that processes the second input data.

Since the single-type data processing hierarchy unit performs reduced processing, the accuracy of a final inference result may be decreased to some extent, but processing time decreases instead. In a real-time system in which an inference result from the neural network needs to be output within a specific time, in a case where preparation of the second input data is delayed, the neural network model illustrated in FIG. 6B is used. With this configuration, it is possible to synchronize processing completion times at the single-type data processing hierarchy unit for the first input data and the second input data that is input with a delay. This prevents occurrence of a delay in timing of data input to the multiple-type data processing hierarchy unit. Accordingly, even in the case where the preparation of the second input data is delayed, it is possible to complete the processing within the specific time.

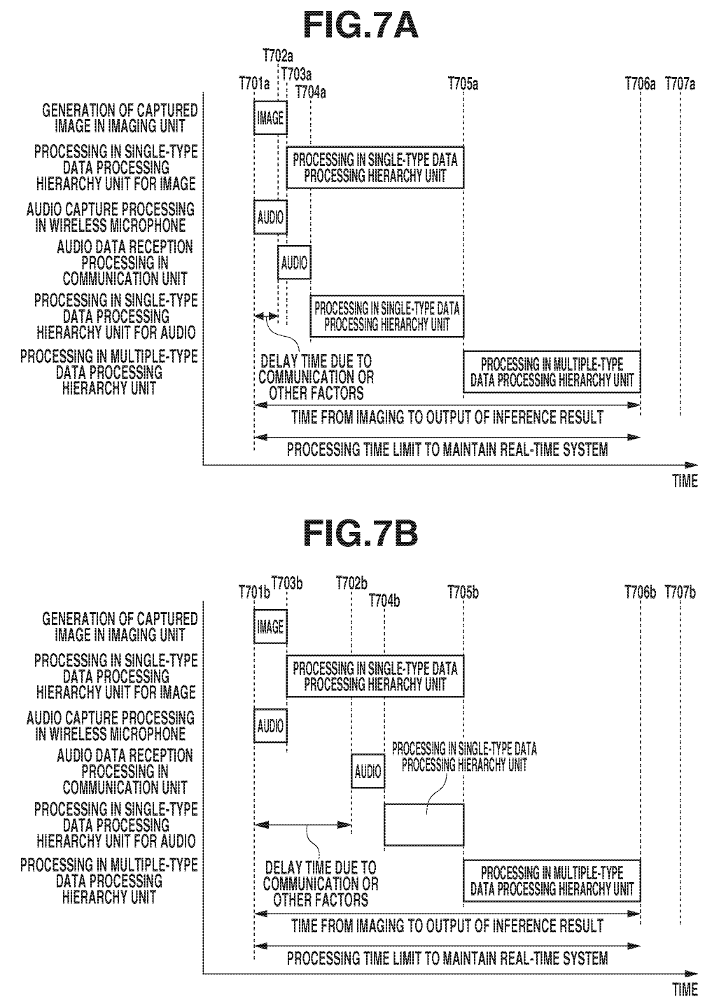

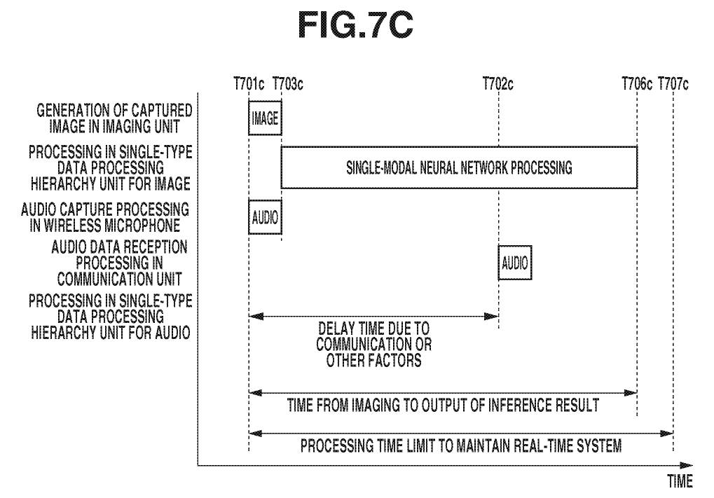

A timing of each processing will be described below with reference a timing chart in FIGS. 7A to 7C.

FIG. 6C illustrates an example of the single-modal neural network model determined in step S504 in FIG. 5. In a case where the preparation of the second input data is significantly delayed, it is necessary to complete the processing using only the first input data to maintain a real-time property. This is the neural network model used in such cases. While it is not possible to improve the accuracy of an inference result using the multi-modal neural network model, it is possible to complete the processing within the specific time.

As described above, in FIG. 5, the control unit 201 determines to use one neural network model among the plurality of neural network models that receives input of either or both of the first and second input data in steps S503, S504, and S506 depending on the delay value calculated in step S303 in FIG. 3.

Each of the neural network models determined in step S503 and step S506 is the neural network model that receives input of both the first and second input data as illustrated in FIGS. 6A and 6B.

The neural network model determined in step S504 is the neural network model that receives input of the first input data but does not receive input of the second input data as illustrated in FIG. 6C.

In a case where the delay value is a predetermined value or less, the control unit 201 determines to use the neural network determined in step S503 or S506. In a case where the delay value is not the predetermined value or less, the control unit 201 determines to use the neural network determined in step S504.

Each of the neural network models illustrated in FIGS. 6A and 6B includes a first single-type data processing hierarchy unit that processes the first input data, a second single-type data processing hierarchy unit that processes the second input data, and a multiple-type data processing hierarchy unit that processes output results from the first single-type data processing hierarchy unit and the second single-type data processing hierarchy unit.

For example, the first input data is the captured image data, and the second input data is the audio data.

The second single-type data processing hierarchy unit in the neural network model illustrated in FIG. 6B performs a smaller amount of computation than that of the second single-type data processing hierarchy unit in the neural network model illustrated in FIG. 6A.

The neural network model determined in step S503 is a neural network model trained based on the difference between the input times of the first input data and the second input data.

Subsequently, an example of a timing chart of a series of processes associated with the neural network processing is described with reference to FIGS. 7A to 7C.

FIG. 7A illustrates a timing chart when a delay in reception of the audio data from the wireless microphone 101 is small and the neural network model illustrated in FIG. 6A is used.

Time T701a indicates a timing at which the imaging unit 202 starts capturing an image. The wireless microphone 101 constantly captures external audio, but in FIG. 7A, for ease of understanding, only an audio capture period of audio data to be subjected to multi-modal processing identical to that performed on the captured images is illustrated. The wireless microphone 101 transmits audio data started to be captured at time T701a to the signal processing apparatus 100.

At time T702a, the communication unit 211 of the signal processing apparatus 100 starts receiving initial data of the audio data transmitted from the wireless microphone 101. More specifically, a period from time T701a to time T702a corresponds to a delay time due to a communication delay or the like. The delay time is determined depending on processing performance of the wireless microphone 101, a communication protocol to be used, a network congestion state, and the like.

At time T703a, the imaging unit 202 completes imaging for one screen. When the imaging is completed, the control unit 201 transmits the captured image data to the neural network processing unit 213, and the neural network processing is started. In FIG. 7A, since the delay time of the audio data is short, the multi-modal processing is performed. The control unit 201 starts processing in the single-type data processing hierarchy unit that receives input of the captured image data as the first input data.

At time T704a, upon completion of reception of the audio data for a period equivalent to an imaging period in which a captured image is captured, the control unit 201 transmits the received audio data to the neural network processing unit 213, and the neural network processing is started. The control unit 201 starts processing in the single-type data processing hierarchy unit that receives input of the audio data as the second input data.

At time T705a, the neural network processing unit 213 completes the processing on the first input data and the second input data in the respective single-type data processing hierarchy units, hands over processing results to the multiple-type data processing hierarchy unit, and starts processing in the multiple-type data processing hierarchy unit.

At time T706a, the neural network processing unit 213 completes the processing in the multiple-type data processing hierarchy unit and completes the neural network processing.

Time T707a indicates a time limit necessary to maintain the real-time system from the start of imaging to the completion of the processing. It is necessary to complete the neural network processing by this time. In FIG. 7A, a delay in reception of the audio data from the wireless microphone 101 is small. Thus, even if multi-modal processing with many processing hierarchies is performed on the audio data received from the wireless microphone 101, it is possible to complete the neural network processing by time T707a.

FIG. 7B illustrates a timing chart in a state where a delay in reception of the audio data from the wireless microphone 101 is larger than that in FIG. 7A, and when the neural network model that performs reduced processing on the audio data illustrated in FIG. 6B is used.

Time T701b, similar to time T701a, indicates a timing at which the imaging unit 202 starts capturing an image.

Time T703b is a timing equivalent to time T703a, and the imaging unit 202 completes imaging for one screen.

Time T702b is a timing at which the communication unit 211 of the signal processing apparatus 100 starts receiving initial data of the audio data from the wireless microphone 101, but is significantly delayed in comparison with time T702a. Thus, the communication unit 211 receives the data in a state where the processing on an image in the single-type data processing hierarchy unit has advanced halfway. Here, if the neural network model illustrated in FIG. 6A is used, the processing on the audio data in the single-type data processing hierarchy unit is delayed, and it is not possible to complete the neural network inference processing by time T707b. Thus, the neural network model that performs reduced processing on audio in the single-type data processing hierarchy unit illustrated in FIG. 6B is used.

Time T704b is a time at which the reception of the audio data is completed. Time required to receive the audio data, from time T702b to time T704b, is equivalent to time from time T702a to time T704b.

Time T705b is a time at which the processing in the single-type data processing hierarchy unit is completed. Although the acquisition of the audio data is significantly delayed, the neural network model that performs reduced processing on audio data is used, which makes it possible to complete the processing on the captured image data and the audio data at equivalent times.

Similar to time T706a, time T706b is a time at which the processing in the multiple-type data processing hierarchy unit is completed and the neural network processing is completed.

Similar to time T707a, time T707b is a time limit for maintaining the real-time system. Since the processing is completed at time T706b before time T707b, no problem occurs.

Subsequently, FIG. 7C illustrates a state where the reception of the audio data from the wireless microphone 101 is significantly delayed, and the processing cannot be completed within the real-time constraint by execution of multi-modal neural network processing. In this state, if the multi-modal neural network model is used, the real-time system fails, and thus it is necessary to use the neural network model illustrated in FIG. 6C, which is the single-modal neural network. FIG. 7C illustrates a timing chart for such a case.

Time T701c is similar to time T701a.

At time T702c, the reception of the audio data from the wireless microphone 101 is significantly delayed. Even if the multi-modal neural network processing is started from this timing, it is not possible to complete the processing by time T707c that is the real-time constraint. Thus, the audio data received is not used in the neural network processing.

At time T703c, the control unit 201 inputs the image data generated by the imaging unit 202 as input data to the single-modal neural network model, and starts the neural network processing.

At time T706c, the neural network processing unit 213 completes the single-modal neural network processing on the input image data.

Time T707c is the real-time constraint. However, since the processing is completed at time T706c before time T707c, no problem occurs.

As described above, in the real-time system in which the neural network processing is completed within a specific time using multiple types of data, by using the neural network model provided with the single-type data processing hierarchy unit that performs an amount of processing depending on a delay of input data, it is possible to complete the processing within the specific time while suppressing a decrease in accuracy of an inference result.

In deep-learning processing in which a plurality of pieces of input data is input, in a case where some pieces of input data are delayed among the plurality of pieces of input data, the signal processing apparatus 100 uses a neural network model in consideration of processing on delayed input data and can thereby complete the processing within a specific time while suppressing a decrease in accuracy of an inference result.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213347, filed December 6, 2024, which is hereby incorporated by reference herein in its entirety.

What is claimed is:

1. A signal processing apparatus comprising:
a generation unit configured to generate one or more pieces of first input data;
a reception unit configured to receive one or more pieces of second input data from an external device;
a calculation unit configured to calculate a delay value of the second input data with respect to the first input data; and
a determination unit configured to determine that one neural network model among a plurality of neural network models is to be used, the neural network model receiving input of either or both of the first input data and the second input data depending on the delay value calculated by the calculation unit.

2. The signal processing apparatus according to claim 1, wherein the determination unit is configured to determine that either a first neural network model that receives input of both the first input data and the second input data or a second neural network model that receives input of the first input data and that does not receive input of the second input data is to be used.

3. The signal processing apparatus according to claim 2, wherein, in a case where the delay value is a predetermined value or less, the determination unit determines that the first neural network model is to be used, and in a case where the delay value is not the predetermined value or less, the determination unit determines that the second neural network model is to be used.

4. The signal processing apparatus according to claim 2, wherein the first neural network model includes:
a first single-type data processing hierarchy unit configured to process the first input data;
a second single-type data processing hierarchy unit configured to process the second input data; and
a multiple-type data processing hierarchy unit configured to process an output result from the first single-type data processing hierarchy unit and an output result from the second single-type data processing hierarchy unit.

5. The signal processing apparatus according to claim 1,
wherein the determination unit is configured to:
determine that, in a case where the signal processing apparatus is in a first mode and the delay value is a first predetermined value or less, a first neural network model that receives input of both the first input data and the second input data is to be used;
determine that, in a case where the signal processing apparatus is in the first mode and the delay value is not the first predetermined value or less, a second neural network model that receives input of the first input data and that does not receive input of the second input data;
determine that, in a case where the signal processing apparatus is in a second mode and the delay value is the first predetermined value or less, a third neural network model that receives input of both the first input data and the second input data is to be used; and
determine that, in a case where the signal processing apparatus is in the second mode and the delay value is not the first predetermined value or less, the second neural network model is to be used,
wherein the first neural network model and the third neural network model each include:
a first single-type data processing hierarchy unit configured to process the first input data;
a second single-type data processing hierarchy unit configured to process the second input data; and
a multiple-type data processing hierarchy unit configured to process an output result from the first single-type data processing hierarchy unit and an output result from the second single-type data processing hierarchy unit, and
wherein the second single-type data processing hierarchy unit of the third neural network model is configured to perform less computation than the second single-type data processing hierarchy unit of the first neural network model.

6. The signal processing apparatus according to claim 5, wherein the first neural network model is a neural network model trained based on a difference between a time of input of the first input data and a time of input of the second input data.

7. The signal processing apparatus according to claim 1,
wherein the reception unit receives time information regarding a time of generation of the first input data from the external device, and
wherein the calculation unit calculates a difference between the time information regarding the time of generation of the first input data and a time of the signal processing apparatus as the delay value.

8. The signal processing apparatus according to claim 7, further comprising a synchronization communication unit configured to perform time synchronization communication to synchronize time with the external device.

9. The signal processing apparatus according to claim 1, wherein the reception unit is configured to wirelessly receive the second input data.

10. The signal processing apparatus according to claim 1,
wherein the first input data is captured image data, and
wherein the second input data is audio data.

11. The signal processing apparatus according to claim 10, wherein the external device is a wireless microphone.

12. A processing method for a signal processing apparatus, the method comprising:
generating one or more pieces of first input data;
receiving one or more pieces of second input data from an external device;
calculating a delay value of the second input data with respect to the first input data; and
determining that one neural network model among a plurality of neural network models is to be used, the neural network model receiving input of either or both of the first input data and the second input data depending on the calculated delay value.

13. A non-transitory computer-readable storage medium storing a program for causing a computer to execute as a processing method for a signal processing apparatus, the method comprising:
generating one or more pieces of first input data;
receiving one or more pieces of second input data from an external device;
calculating a delay value of the second input data with respect to the first input data; and
determining that one neural network model among a plurality of neural network models is to be used, the neural network model receiving input of either or both of the first input data and the second input data depending on the calculated delay value.
